(19) United States
(12) Patent Application Publication
(10) Pub. No.: US 2007/0213992 A1
(43) Pub. Date: Sep. 13, 2007

(54) Verifying a usage of a transportation resource

(75) Inventors: Gary F. Anderson, Danbury, CT (US); Mark S. Ramsey, Kihei, HI (US); Charles J. Schott, Brookfield, CT (US); David A. Selby, Nr Fareham (GB)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/371,133

(22) Filed: Mar. 7, 2006

(51) Int. Cl. G06Q 10/00; G06Q 30/00

(52) U.S. Cl. 705/1

(57) ABSTRACT

A method, system and computer program product for verifying a usage of a transportation resource by an object user of the transportation resource is disclosed. A peer group of users that are expected to behave similarly as the object user is established to determine a normal behavior that the object user is supposed to act consistent with. An observed behavior of the object user is compared to the normal behavior to verify a usage of the transportation resource by the object user.

### FIELD OF THE INVENTION

The invention relates generally to a usage of a transportation resource and more particularly to the verification of a usage of a transportation resource.

### BACKGROUND OF THE INVENTION

Transportation resources are limited. As a consequence, accesses to the limited transportation resources need to be distributed in a rational manner. For example, a new trend is emerging in the world as a method to reduce traffic congestion and to assign the cost impact of transportation resources to those consuming the resources, which is normally referred as road user charging. Road user charging requires active monitoring of vehicles and their use of roads, including, e.g., a chargeback for the use of congested segments at peak times. The process may also provide alternative routes which provide faster service at a higher cost, or even vary the cost of a road segment, e.g., a tunnel or bridge, to reduce congestion at peak times.

In a recent business model, users of transportation resources must pay for their usage through some means, for example, various fuel taxes. The amount of fuel tax paid is tied to the amount of fuel purchased within the defined geographic area of the government overseeing the transportation. If a user does not pay the appropriate amount in fuel taxes for its amount of usage of transportation resources in a defined specific geographic area, additional costs would be collected via other means. On the other hand, if a user pays too much in fuel taxes with respect to the actual usage of the transportation resources, refunds in fees would be made to the user.

Within this business model, it is important to prevent fraud or abuse of a transportation resource distribution/charging system. If a vehicle fraudulently shows lower usage than the actual usage, an undeserved refund in fees would occur. On the other hand, a situation might be that an overage in fuel tax payments results in a miss-match of payment and usage. As a consequence, incompliant behaviors in this model, such as frauds or abuses, will cause compliance costs to rise to offset the loss due to incompliant behaviors.

Given the emerging nature of this business model, no specific solution exists in the market today to provide a safeguard required to verify a usage of the transportation resources to prevent potential fraud regarding the charging of transportation resource usage. Based on the above, there is a need to verify a usage of a transportation resource.

### BRIEF SUMMARY OF THE INVENTION

A method, system and computer program product for verifying a usage of a transportation resource by an object user of the transportation resource is disclosed. A peer group of users that are expected to behave similarly as the object user is established to determine a normal behavior that the object user is supposed to act consistent with. An observed behavior of the object user is compared to the normal behavior to verify a usage of the transportation resource by the object user.

A first aspect of the invention is directed to a method for verifying a usage of a transportation resource by an object user of the transportation resource, the method comprising steps of: selecting a peer group of users that are expected to have similar behavior as the object user; identifying a set of behavioral attributes of the peer group; determining a normal behavior of the peer group regarding the identified set of behavioral attributes; and comparing a behavior of the object user to the normal behavior regarding the identified set of behavior attributes to verify the usage of the object user.

A second aspect of the invention is directed to a system for verifying a usage of a transportation resource by an object user of the transportation resource, the system comprising: a means for selecting a peer group of users that are expected to have similar behavior as the object user; a means for identifying a set of behavioral attributes of the peer group; a means for determining a normal behavior of the peer group regarding the identified set of behavioral attributes; and a means for comparing a behavior of the object user to the normal behavior regarding the identified set of behavior attributes to verify the usage of the object user.

A third aspect of the invention is directed to a computer program product for verifying a usage of a transportation resource by an object user of the transportation resource, the computer program product comprising: computer usable program code configured to: select a peer group of users that are expected to have similar behavior as the object user; identify a set of behavioral attributes of the peer group; determine a normal behavior of the peer group regarding the identified set of behavioral attributes; and compare a behavior of the object user to the normal behavior regarding the identified set of behavior attributes to verify the usage of the object user.

A fourth aspect of the invention is directed to a method of generating a system for verifying a usage of a transportation resource by an object user of the transportation resource, the method comprising: providing a computer infrastructure operable to: select a peer group of users that are expected to have similar behavior as the object user; identify a set of behavioral attributes of the peer group; determine a normal behavior of the peer group regarding the identified set of behavioral attributes; compare a behavior of the object user to the normal behavior regarding the identified set of behavior attributes to verify the usage of the object user; and communicate a result of the verification to a customer of the system.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

The embodiments of this invention will be described in detail, with reference to the following figures, wherein like designations denote like elements, and wherein:

FIG. 1 shows a schematic view of an illustrative-transportation resource usage charging system according to one embodiment of the invention.

FIG. 2 shows a block diagram of an illustrative computer system according to one embodiment of the invention

FIG. 3 shows a flow diagram of one embodiment of a historic analysis operation of a transportation resource usage verifying system according to the invention.

FIG. 4 shows a flow diagram of one embodiment of a prospective analysis operation of the transportation resource usage verifying system according to the invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

### 1. System Overview

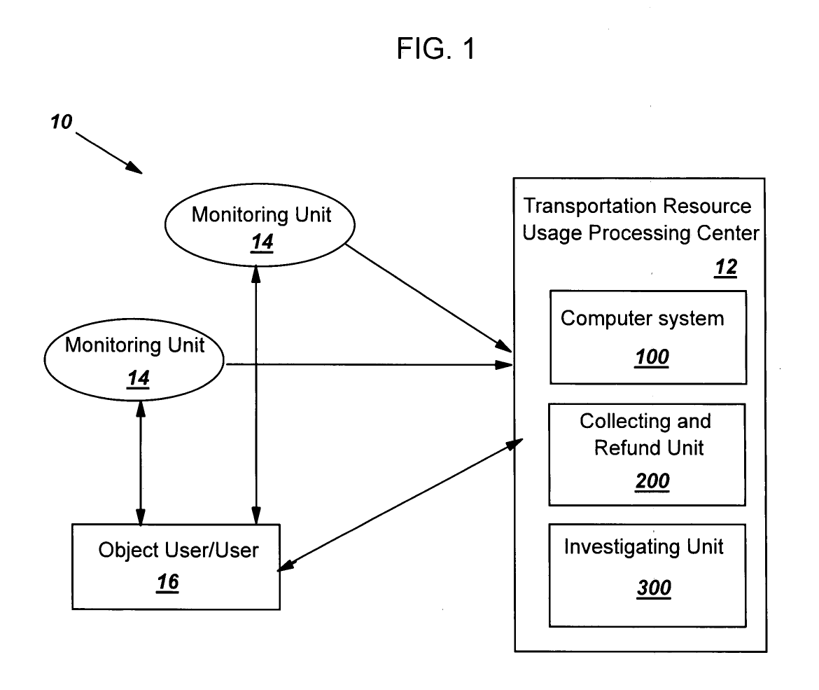

Referring to FIG. 1, a schematic view of an illustrative transportation resource usage charging system 10 is shown. According to one embodiment, charging system 10 includes a transportation resource usage processing center 12 including a computer system 100, a collecting and refund unit 200 and an investigating unit 300; and multiple monitoring units 14 (two are shown). Monitoring units 14 detect a behavior of a user 16 regarding the usage of a transportation resource by collecting usage data including, e.g., mileage, fuel consumption, routes taken, times of use and taxes paid. Monitoring units 14 may include any devices that can monitor user 16 regarding the usage of a transportation resource, and may be installed conveniently in, for example, road checkpoints, toll booths, gas stations, or in the vehicle of user 16 monitored, such as, for example, a Global Positioning System (GPS) device.

User 16 communicates with processing center 12 regarding, for example, usage of the transportation resource, taxes paid, refunds and/or additional charges to be collected. User 16 also communicates with monitoring units 14 in the process of data collecting. For example, user 16 pays fuel tax in gas stations and pays highway fees in toll booths. In charging system 10, an object user (16) is generally a user (16) of a transportation resource. However, for illustrative purposes only, in the following description, a user (16) is referred as an object user (16) when this user's case is processed by processing center 12, e.g., when the usage of a transportation resource by this specific user is to be verified as described below. It should be noted that in charging system 10, regardless of whether a user is an object user, its usage of transportation resources is monitored because: (a) any user may potentially become an object user, and (b) any user may be selected into a peer group as described later. Details of computer system 100 of processing center 12 will be described below.

### 2. Computer System

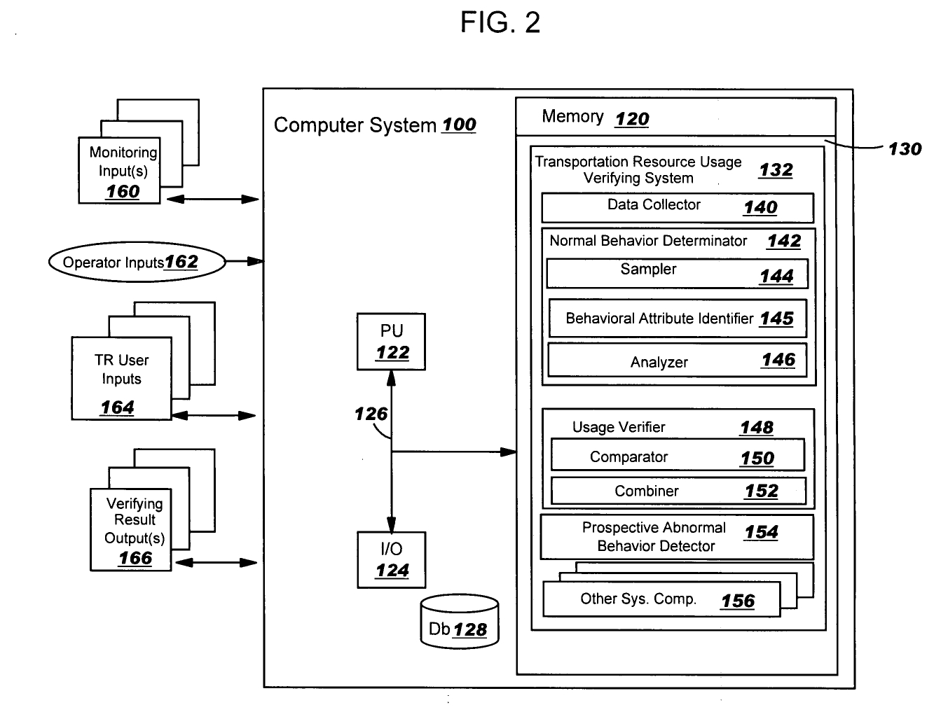

Referring to FIG. 2, a block diagram of an illustrative computer system 100 according to the present invention is shown. In one embodiment, computer system 100 includes a memory 120, a processing unit (PU) 122, input/output devices (I/O) 124 and a bus 126. A database 128 may also be provided for storage of data relative to processing tasks. Memory 120 includes a program product 130 that, when executed by PU 122, comprises various functional capabilities described in further detail below. Memory 120 (and database 128) may comprise any known type of data storage system and/or transmission media, including magnetic media, optical media, random access memory (RAM), read only memory (ROM), a data object, etc. Moreover, memory 120 (and database 128) may reside at a single physical location comprising one or more types of data storage, or be distributed across a plurality of physical systems. PU 122 may likewise comprise a single processing unit, or a plurality of processing units distributed across one or more locations. I/O 124 may comprise any known type of input/output device including a network system, modem, keyboard, mouse, scanner, voice recognition system, CRT, printer, disc drives, etc. Additional components, such as cache memory, communication systems, system software, etc., may also be incorporated into computer system 100.

As shown in FIG. 2, program product 130 may include a transportation resource usage verifying system 132 that includes a data collector 140; a normal behavior determinator 142 including a sampler 144, a behavioral attribute identifier 145 and an analyzer 146; a usage verifier 148 including a comparator 150 and a combiner 152; a prospective abnormal behavior detector 154; and other system components 156. Other system components 156 may include any now known or later developed parts of a computer system 100 not individually delineated herein, but understood by those skilled in the art.

Inputs to computer system 100 include monitoring inputs 160, operator inputs 162 and transportation resource (TR) user inputs 164. Monitoring inputs 160 include the data collected by monitoring units 14 (FIG. 1). Operator inputs 162 include instruction of an operator of computer system 100 regarding the operation of, inter alia, transportation resource usage verifying system 132, as will be described in details below. Transportation resource user inputs 164 include usage data that are reported by user/object user 16 (FIG. 1). Those inputs may be communicated to computer system 100 through I/O 124 and may be stored in database 128. Outputs of computer system 100 include verifying result outputs 166 that are communicated to, inter alia, collecting and refund unit 200 and investigating unit 300 for them to act accordingly. For example, if a usage of object user 16 (FIG. 1) is verified as reliable, e.g., no fraud involved, collecting and refund unit 200 will process a refund or further collecting of fees according to the verified usage. On the other hand, if a usage of object user 16 is determined as unreliable, e.g., possible frauds involved, investigating unit 300 will proceed with further investigation regarding object user 16. The operation of transportation resource usage verifying system 132 will be described in details below.

### 3. Transportation Resource Usage Verifying System

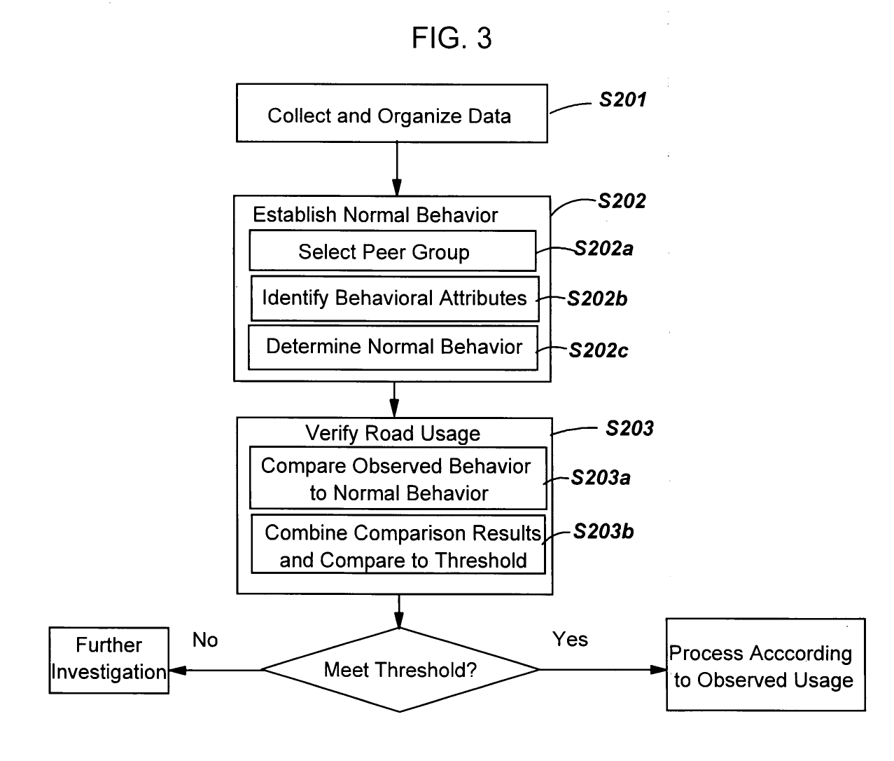

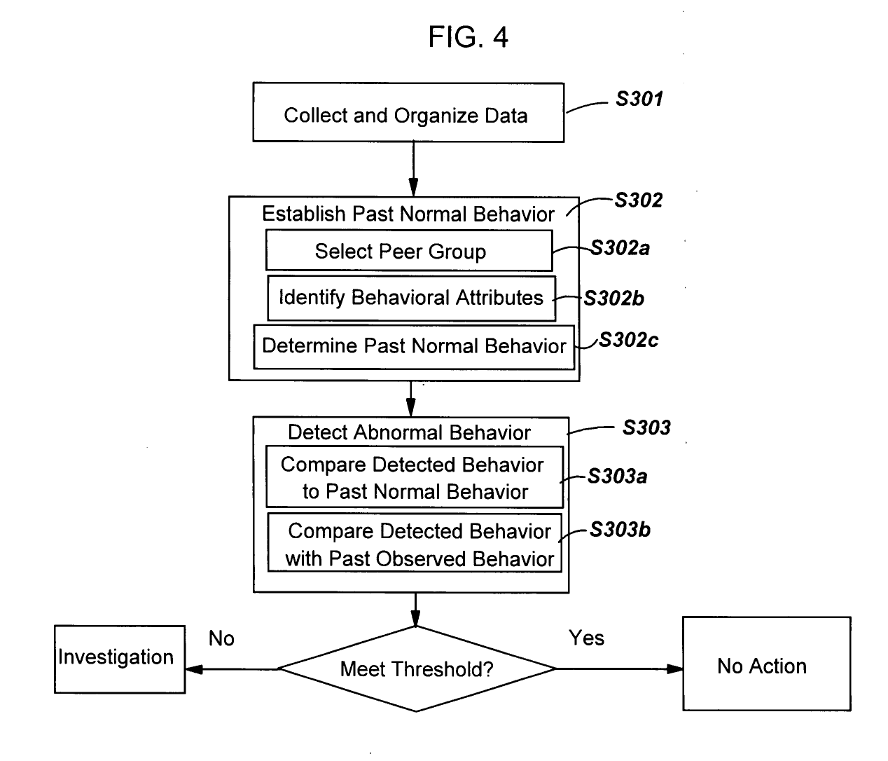

Transportation resource usage verifying system 132 functions generally to verify whether an observed usage of a transportation resource that is to be used to process a usage charge represents the actual usage by an object user 16 (FIG. 1). Please note a usage used to process a usage charge is always an observed usage because the actual usage can never be replicated. As such, in this description, “usage” is equivalent to “observed usage”, and “actual usage” is used to indicate the actual usage that has occurred. An observed usage may be obtained by monitoring an object user's usage through monitoring units 14 (FIG. 1), for example, fuel tax payments monitored by monitoring units 14 in gas stations may be used to determine an observed usage. The observed usage may also be obtained through the usage reported by object user 16. It should be understood that an observed usage (either monitored or reported) may not represent the actual usage due to, e.g., possible fraudulent actions involved in the reporting and/or monitoring process. Even if there are no fraudulent actions involved, an observed usage may still not represent the actual usage for various reasons. For example, in the case that fuel tax is used to calculate an observed usage, if a user purchases gas in the geographic area of concern but uses the vehicle in another area, the observed usage calculated based on fuel tax paid will not represent the actual usage of the transportation resources in the geographic area of concern. One embodiment of the operation of transportation resource usage verifying system 132 is shown in the flow diagrams of FIGS. 3 and 4. In the following descriptions of the flow diagrams of FIGS. 3 and 4, a road system (or roads) is used as an example of transportation resources for illustrative purpose. It should be understood that transportation resources are not limited to a road system, and a verification of the usage of other transportation resources is similarly included in the scope of the present invention.

According to one embodiment, the processing of collecting and refund by collecting and refund unit 200 (FIG. 1) regarding each object user 16 is performed periodically. By the end of each processing period, usage of road by object user 16 during the period (past usage) will be first verified by transportation resource usage verifying system 132 before it is processed by collecting and refund unit 200. The verification of past usage that is to be processed to collect fees or issue refunds is referred to as historic analysis, for illustrative purpose only. It should be noted that the historic analysis may also be used to correct/certify a collecting and refund action already performed by collecting and refund unit 200. In addition, transportation resource usage verifying system 132 also verifies a road usage of object user 16 (FIG. 1) during a processing period to identify suspect behavior of object user 16. The verification of road usage during a processing period is referred to as prospective analysis, for illustrative purpose only. An embodiment of the historical analysis operation of transportation resource usage verifying system 132 will be shown in the flow diagram of FIG. 3, and an embodiment of the prospective analysis operation of transportation resource usage verifying system 132 will be shown in the flow diagram of FIG. 4.

Referring now to FIG. 3, with reference also to FIG. 2, first in step S201, data collector 140 collects and organizes data to facilitate a further statistical analysis of the data. The data collected include those of monitoring inputs 160 and transportation resource user inputs 164. As described above, data collector 140 collects data of all users 16 in a processing period. According to one embodiment, the data collected may be categorized as including road usage data and user characteristic data. Road usage data may include the data regarding factors that indicate usage of roads, such as mileage, fuel consumption, routes taken, times of use, taxes paid, etc. Generally, road usage data are capable of being quantified, i.e., described as values. The factors that indicate road usage will be referred to as usage indicators, and the data value regarding each usage indicator is referred to as a user's behavior regarding this specific usage indicator. It is understandable that an observed usage of object user 16 is represented by the behaviors of object user 16 regarding the usage indicators. A user's behavior may also refer to a relationship between and among the user's behavior regarding each specific usage indicator. That is, the word “behavior” has two levels of meanings in this specification, i.e., in the level of individual usage indicator and in the level of the relationships between and among individual usage indicators.

For each specific user 16 (FIG. 1), the data for usage indicators might have some problems such as missing data or obviously strange data. Those problems need to be resolved by data collector 140 in step S201 before the problematic data is used for further analysis. Road usage data may also need to be treated in step S201 to fit an analysis purpose. For example, in some situations, a categorized type of data might be more suitable than a data of continuous value, so continuous road usage data may need to be converted to categorized data in step S201.

User characteristics data include data regarding characteristics of a user (16) that affect the usage of road by the user (16). As is understandable, user characteristics are generally related to road usage indirectly, i.e., they do not directly indicate road usage, instead they affect road usage. For example, a taxi driver (user characteristic) tends to use road more frequently than an ordinary commute driver, and tends to have low gas/mileage efficiency because of frequent stops. But being a taxi driver does not directly indicate the amount of road usage. In step S201, user characteristic data and road usage data (usage indicators) may be organized together in a table to facilitate further analysis.

Next in step S202, normal behavior determinator 142 determines a normal behavior that object user 16 (FIG. 1) is expected to behave in consistent with. The normal behavior is determined by analyzing a peer group of users having the same (or similar) user characteristics as object user 16. Specifically, in step S202a, sampler 144 establishes/selects a peer group of users that have the same or similar user characteristics as object user 16, who are thus generally expected to behave similarly regarding road usage indicators as object user 16. Here the meaning of behaving similarly regarding road usage include, but is not limited to, similar behavior (i.e., value) regarding each usage indicator and similar relationships between and among usage indicators. For example, if object user 16 is a taxi driver, a group of other taxi drivers working in the similar region of the same city as object user 16 might be selected to establish a peer group. For each taxi driver (road user) in this peer group, it is expected that the relationship between and among road usage indicators (e.g., correlation between fuel consumption and mileage) should be similar. It is understandable that similar behavior regarding each individual road usage indicator is a different standard than similar relationship between and among road usage indicators. The selection of peer group may be dependent upon which standard is used. In the operation of transportation resource usage verifying system 132, an operator of the system may instruct verifying system 132 regarding which standard is used for a specific kind of object user 16, through operator input 162.

It should be noted that road usage indicators may also be used, independently or together with user characteristics data, to select peer groups. For example, a group of users 16 having similar behaviors regarding some of the road usage indicators may be expected to have similar behaviors regarding other road usage indicators. In the following description, however, selection of a peer group using user characteristics data is used as an illustrative example for descriptive purpose only.

It should also be noted that the selection of a peer group is performed by verifying system 132, specifically sampler 144, independent of user 16 interventions. No information regarding the peer group selection, for example, standards, procedures, and/or results, will be communicated to user 16. This is to ensure that object user 16 and other users having the potential of being selected into a peer group will not coordinate in a fraudulent type of actions, which will be more difficult to detect.

According to one embodiment, in step S202a, sampler 144 first identifies a pool of all the users that have the same (or similar) user characteristics as object user 16. Next, sampler 144 samples a peer group from the pool. One reason for sampling a peer group from the pool is to save system resources of computer system 100 (FIG. 2), for example, the memory space required for further calculation. It should be understood that in some situations, sampling may not be necessary or may not be desirable. For example, if the pool itself is not big or if the potential sampling errors are not acceptable, the pool of all the users having the same (or similar) user characteristics as object user 16 may be used as the peer group. The sampling may utilize any now known or future developed methods of sampling, for example, random sampling or representative sampling.

Next in step S202b, behavioral attribute identifier 145 identifies a set of usage indicators, regarding which object user 16 is expected to behave similarly as the peer group identified in step S202a. The identified set of usage indicators is referred to as behavioral attributes, for illustrative purpose only. For a specific object user 16, it may not be expected that he behaves similarly regarding all road usage indicators, instead it is expected that object user 16 behaves similarly regarding some usage indicators. For example, an object taxi driver (user) may be expected to behave similarly regarding gas mileage as his peer group, but may not be expected to take the similar routes as detected by, e.g., a GPS device in the taxi car, as the peer group. Please note, behaving similarly includes similar behavior regarding each behavioral attribute or similar relationship between and among the behavioral attributes.

According to one embodiment, the selection of behavioral attributes may be based on statistical analysis of the behaviors of the selected peer group regarding road usage indicators. For example, a standard deviation of the peer group behaviors regarding a specific road usage indicator may be compared to a threshold, for example, standard deviation being less than 5 percent of mean. If the standard deviation of the peer group behaviors regarding a specific road usage indicator meets the threshold, that specific road usage indicator may be selected as a behavioral attribute.

According to an alternative embodiment, the selection of behavioral attributes may be based on empirical data/past cases of fraud in road usage charging. For example, past cases of fraud may show that for a user with a specific kind of user characteristic, frauds in road usage charging generally involve strange behaviors regarding a certain road usage indicators. The certain road usage indicators may be selected as the behavioral attributes. It should be noted that any now known or later developed methods of selecting behavior attributes are also included in the current invention. It should also be noted that those methods may used independently or in combination in selecting behavior attributes.

Next in step S202c, normal behavior determinator 142 determines a normal behavior of the peer group selected for object user 16 regarding the set of behavioral attributes identified in step S202b. Various methods may be used to determine the normal behavior. According to one embodiment, if the identified behavioral attributes have some kinds of causal or non-causal relationship, a statistical description of the relationship, such as a correlation table or a regression equation may be used to identify the normal behavior. For example, a mileage of a vehicle of object user 16 may be related to fuel consumption, time of use (e.g., whether peak traffic time or not), route taken (e.g., highway or not), and age of object user 16, etc. Using the data of the peer group, a regression equation may be obtained as follows:
Mileage=A*Fuel+B*Time+C*Route+D*age (1)
Regression equation (1) may be used to describe the normal behavior. As described above, object user 16 behaving similarly as the peer group includes similar relationship between and among the behaviors (data values) regarding each behavioral attribute as the peer group. Regression equation (1) represents such a similar relationship. That is, if the behaviors (data values) of object user 16 regarding behavioral attributes, e.g., mileage, fuel consumption, time of use, route taken, and age, conform to equation (1), object user 16 is considered behaving similarly as the peer group.

According to an alternative embodiment, especially when the identified behavioral attributes do not have a reasonable relationship, the statistical mean of the behaviors of the peer group regarding a behavioral attribute may be selected as the normal behavior regarding this behavioral attribute. The statistical mean may be either average or median depending on the specific object user 16 and the peer group. According to one embodiment, an average is a better choice because a standard deviation is calculated based on the average, instead of the median. As will be described below, a standard deviation will be used in further analysis. It should be noted that any now existing and later developed methods of determining a normal behavior are included in the scope of the present invention.

Next in step S203, usage verifier 148 verifies an observed road usage of object user 16. Specifically, in step S203a, comparator 150 compares the behavior of object user 16 with the normal behavior determined in step S202 regarding the identified set of behavioral attributes. The specific procedure of the comparison depends on how the normal behavior is determined in step S202c. According to one embodiment, if the normal behavior is determined using, e.g., regression equation (1), comparator 150 incorporates the observed behaviors of object user 16 (FIG. 1) regarding the identified behavioral attributes, except for mileage, into equation (1) to obtain a mileage value and compares this obtained mileage value with the observed mileage of object user 16. If the difference between the observed mileage and the obtained mileage is within a preset threshold, it is considered that the observed mileage represents the actual mileage and the observed usage represents the actual usage.

Similarly, comparator 150 may obtain an obtained value for each of the identified behavioral attributes and compare the obtained value with the observed value. A difference between the obtained value and the observed value of each behavioral attribute may be converted into a score between 0 and 1000. Any now known and later developed score normalization procedures may be used in the conversion, and are included in the present invention. Because the details of the conversion are not necessary for an understanding of the invention, further details will not be provided.

According to an alternative embodiment, if the normal behavior is determined using the mean of the peer group behaviors regarding each identified behavioral attribute, comparator 150 compares the observed behavior of object user 16 with the normal behavior with respect to each of the identified set of behavioral attributes. The difference between the observed behavior and the normal behavior with respect to each behavioral attribute may be converted into a 0 to 1000 score using the same procedure described above. It should be noted that any now existing or later developed method of comparing an observed behavior with the normal behavior are included in the current invention.

Next in step S203b, combiner 152 combines the comparison results, i.e., the scores, with respect to each behavioral attribute to generate an overall comparison results, i.e., a combined score. The combined score may be compared to a threshold to determine whether the observed usage represents the actual usage of object user 16 (FIG. 1), i.e., to verify the observed usage of object user 16. According to one embodiment, the scores with respect to the individual behavioral attributes are averaged to obtain a combined score. According to an alternative embodiment, the score with respect to each behavioral attribute is first weighed according to the behavioral attribute's relative importance in verifying road usage before the score is combined with others to obtain a combined score.

If the combined score is larger than a pre-set threshold, i.e., not meeting the threshold, the observed usage is considered not representing the actual usage, and it is considered that a fraud is probably involved in obtaining the observed usage. In this case, verifying system 132 will communicate the verifying result to investigating unit 300 through verifying result outputs 166 (FIG. 2) for further investigation of object user 16. If the combined score is smaller than the preset threshold, i.e., meeting the threshold, the observed usage is considered representing the actual usage. In this case, verifying system 132 will communicate the verifying result to collecting and refund unit 200 through verifying result outputs 166, for collecting and refund unit 200 to process fee collecting or refunding therein according to the observed usage.

Referring now to FIG. 4, which shows one embodiment of the prospective analysis operation of transportation resources usage verifying system 132. In the embodiment shown in FIG. 4, the steps S301 to S302 are the same as the steps S201 to S202 of the historic analysis operation shown in FIG. 3. As described above, a prospective analysis is performed during a processing period of processing center 12, when computer system 100 does not have all the data required to determine a normal behavior (steps S202). As such, the data used in steps S301 to S302 are those collected in a proceeding processing period. As a consequence, for a specific object user 16, steps S301 to S302 are the same as steps S201 to S202 of a historic analysis operation of the preceding processing period and might be skipped. Because the data used in steps S301 to S302 are those from the preceding processing period, the normal behavior determined (obtained) in step S302 is referred to as past normal behavior, for illustrative purpose only.

Next in step S303, prospective abnormal behavior detector 154 detects an abnormal behavior of object user 16 before an observed usage of object user 16 is to be processed by processing center 12 and verified by verifying system 132 in a historic analysis operation. Specifically, in step S303a, perspective abnormal behavior detector 154 compares a behavior of object user 16 detected by monitoring units 14 (FIG. 1) with the past normal behavior of the peer group using the same procedures as step S203 as described above. Please note, in a prospective analysis, observed behaviors of object user 16 are usually those detected by monitoring units 14 because object user 16 may not report usage during a processing period. However, a prospective analysis using a reported behavior of object user 16 is similarly included in the present invention.

Next in step S303b, prospective abnormal behavior detector 154 compares a behavior of object user 16 detected by monitoring units 14 (FIG. 1) with the past observed behavior of object user 16 itself. The past observed behavior may be obtained using the behavior of object user 16 in the immediate preceding processing period, or may be obtaining using an average of the behaviors of object user 16 in a serial of preceding processing periods. If, in either step S303a or S303b or both, the comparison result does not meet a preset threshold, the detected behavior of object user 16 is considered abnormal. In this case, verifying system 132 will communicate the result to investigating unit 300 through verifying result output(s) 166 to further investigate object user 16. If, in both steps S303a and S303b, the comparison results meet the preset threshold, the detected behavior of object user 16 is considered normal. In this case, no further action will be taken.

### 4. Conclusion

While shown and described herein as a method and system for verifying a usage of a transportation resource, it is understood that the invention further provides various alternative embodiments. For example, in one embodiment, the invention provides a program product stored on a computer-readable medium, which when executed, enables a computer infrastructure to verify a usage of a transportation resource. To this extent, the computer-readable medium includes program code, such as computer system 100 (FIG. 2), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 120 (FIG. 2) and/or database 128 (FIG. 2), and/or as a data signal traveling over a network (e.g., during a wired/wireless electronic distribution of the program product).

In another embodiment, the invention provides a method of generating a system for verifying a usage of a transportation resource. In this case, a computer infrastructure, such as computer system 100 (FIG. 2), can be obtained (e.g., created, maintained, having made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing system 100 (FIG. 2), from a computer-readable medium; (2) adding one or more computing devices to the computer infrastructure; and (3) incorporating and/or modifying one or more existing systems of the computer infrastructure, to enable the computer infrastructure to perform the process steps of the invention.

In still another embodiment, the invention provides a business method that performs the process described herein on a subscription, advertising supported, and/or fee basis. That is, a service provider could offer to verify a usage of a transportation resource as described herein. In this case, the service provider can manage (e.g., create, maintain, support, etc.) a computer infrastructure, such as computer system 100 (FIG. 2), that performs the process described herein for one or more customers and communicates the results to the one or more customers. In return, the service provider can receive payment from the customer(s) under a subscription and/or fee agreement and/or the service provider can receive payment from the sale of advertising to one or more third parties.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for verifying a usage of a transportation resource by an object user of the transportation resource, the method comprising steps of:
selecting a peer group of users that are expected to have similar behavior as the object user;
identifying a set of behavioral attributes of the peer group;
determining a normal behavior of the peer group regarding the identified set of behavioral attributes; and
comparing a behavior of the object user to the normal behavior regarding the identified set of behavior attributes to verify the usage of the object user.

2. The method of claim 1, further including a step of detecting a behavior of the object user.

3. The method of claim 2, wherein the behavior of the object user is determined based on at least one of a behavior reported by the object user and a detected behavior.

4. The method of claim 2, further comprising a step of detecting an abnormal behavior of the object user before a usage of the object user is to be verified by comparing a detected behavior of the object user with the normal behavior of the peer group.

5. The method of claim 4, wherein the abnormal behavior detecting step further includes comparing the detected behavior of the object user with a past behavior of the object user.

6. The method of claim 1, wherein the normal behavior determining step includes collecting behaviors of the peer group of users and analyzing the collected behaviors of the peer group of users regarding the identified set of behavioral attributes.

7. The method of claim 1, wherein the comparing step include steps of:
comparing the behavior of the object user with the normal behavior with respect to each of the identified set of behavioral attributes; and
combining a result of the comparison with respect to each of the identified set of behavioral attributes to generate an overall comparison result.

8. A system for verifying a usage of a transportation resource by an object user of the transportation resource, the system comprising:
a means for selecting a peer group of users that are expected to have similar behavior as the object user;
a means for identifying a set of behavioral attributes of the peer group;
a means for determining a normal behavior of the peer group regarding the identified set of behavioral attributes; and
a means for comparing a behavior of the object user to the normal behavior regarding the identified set of behavior attributes to verify the usage of the object user.

9. The system of claim 1, further including a means for detecting a behavior of the object user.

10. The system of claim 9, further comprising a means for detecting an abnormal behavior of the object user before a usage of the object user is to be verified by comparing a detected behavior of the object user with the normal behavior of the peer group.

11. The system of claim 10, wherein the abnormal behavior detecting further includes comparing the detected behavior of the object user with a past behavior of the object user.

12. The system of claim 8, wherein the normal behavior determining includes collecting behaviors of the peer group of users and analyzing the collected behaviors of the peer group of users regarding the identified set of behavioral attributes.

13. The system of claim 8, wherein the comparing means is further configured to:
compare the behavior of the object user with the normal behavior with respect to each of the identified set of behavioral attributes; and
combine a result of the comparison with respect to each of the identified set of behavioral attributes to generate an overall comparison result.

14. A computer program product for verifying a usage of a transportation resource by an object user of the transportation resource, the computer program product comprising:
computer usable program code configured to:
select a peer group of users that are expected to have similar behavior as the object user;
identify a set of behavioral attributes of the peer group;
determine a normal behavior of the peer group regarding the identified set of behavioral attributes; and
compare a behavior of the object user to the normal behavior regarding the identified set of behavior attributes to verify the usage of the object user.

15. The program product of claim 14, wherein the computer usable program code is further configured to obtain a detected behavior of the object user.

16. The program product of claim 15, wherein the computer usable program code is further configured to detect an abnormal behavior of the object user before a usage of the object user is to be verified by comparing a detected behavior of the object user with the normal behavior of the peer group.

17. The program product of claim 16, wherein the computer usable program code is further configured to compare the detected behavior of the object user with a past behavior of the object user to detect an abnormal behavior of the object user.

18. The program product of claim 14, wherein the normal behavior determining includes collecting data of behaviors of the peer group of users and analyzing the collected behavior data of the peer group of users regarding the identified set of behavioral attributes.

19. The program product of claim 14, wherein the computer usable program code is further configured to:
compare the behavior of the object user with the normal behavior with respect to each of the identified set of behavioral attributes; and
combine a result of the comparison with respect to each of the identified set of behavioral attributes to generate an overall comparison result.

20. A method of generating a system for verifying a usage of a transportation resource by an object user of the transportation resource, the method comprising: providing a computer infrastructure operable to:
select a peer group of users that are expected to have similar behavior as the object user;
identify a set of behavioral attributes of the peer group;
determine a normal behavior of the peer group regarding the identified set of behavioral attributes;
compare a behavior of the object user to the normal behavior regarding the identified set of behavior attributes to verify the usage of the object user; and
communicate a result of the verification to a customer of the system.
